(19) United States
(12) Patent Application Publication
(10) Pub. No.: US 2020/0118329 A1
(43) Pub. Date: Apr. 16, 2020

(54) OBJECT RESPONSIVE ROBOTIC NAVIGATION AND IMAGING CONTROL SYSTEM

(71) Applicant: Finger Food Studios, Inc., Port Coquitlam (CA)

(72) Inventors: Steven William Pridie, Burnaby (CA); Michael Bell, North Vancouver (CA); Sebastian Unden, Port Moody (CA); Derek Schaper, Maple Ridge (CA); David Gordon, Port Coquitlam (CA)

(21) Appl. No.: 16/653,053

(22) Filed: Oct. 15, 2019

Related U.S. Application Data
(60) Provisional application No. 62/745,834, filed on Oct. 15, 2018.

(51) Int. Cl. G06T 17/00; G06T 7/55; G06T 7/70

(52) U.S. Cl. CPC G06T 17/00; G06T 7/55; G06T 2207/10028; G06T 2207/10004; G06T 7/70

(57) ABSTRACT

There is disclosed a system for generating a three-dimensional model of a physical object including a camera skid placed at a known distance from the physical object and moved fully around the physical object at the known distance, a set of cameras on the camera skid for capturing image data at a series of locations fully around the physical object, and a computing device for generating a three-dimensional model of the physical object using the known distance and the image data.

### RELATED APPLICATION INFORMATION

This patent claims priority from U.S. provisional patent application Ser. No. 62/745,834 filed Oct. 15, 2018 and entitled Object Responsive Robotic Navigation & Imaging Control System” the entirety of which is incorporated herein by reference.

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to three-dimensional imaging and, more particularly, to a system for capturing images and shape characteristics for three-dimensional objects for use in incorporating the resulting three-dimensional models into virtual and augmented reality environments.

### Description of the Related Art

There exist various systems and methods for three-dimensional imaging of objects and people. Most of those systems and methods rely upon complex, multi-camera rigs in fixed locations. In such rigs, pairs of cameras, or in some cases, single cameras, are typically placed in known locations that surround an object or objects to be captured. The cameras are typically used for photogrammetry, or in dual-camera setups stereography, to derive some of the three-dimensional characteristics of the object using known characteristics of the imaged object. Or, in stereography, by using two corresponding points on objects and relying upon a known distance between lenses, focal length and parallax to drive a distance to an object or to different portions of the same object from that known position within the rig. Typically, pairs of cameras are placed at known locations around the rig which surround the object or objects placed in its center. Preferably, a spherical rig is used, though other rig types rely upon bowl structures or hedronic structures.

These rigs are useful for modelling because they can capture high-resolution, well-lit images. The images can be compared using stereography to derive depth data. Adjacent to the camera pairs or near the camera pairs, depth sensors of various types may be employed to provide at least a cross-check or confirmation of depth information. The uniformity of these types of rigs is also helpful. Uniformity of distance from a center point of such rigs enables the system to better account for the overall characteristics of the object being captured. The uniform lighting and distance helps to make the resulting textures, derived from the captured images, match one another in both shadow (or lack thereof) and in calculating the appropriate shapes.

The primary downside of such structures is that they are fixed. Typical spaces within them are on the order of 3-8 feet in diameter at the largest points. As most of these are spherical or partially spherical, the height is typically the same as well. There exist larger rig structures, but they are less common and more expensive as one must set aside the entire space, and incorporate cameras across the entire space that are suitable for imaging the objects within. Many infrared depth sensors cease to be effective at approximately eleven feet in distance from the illuminator. Many depth sensors rely upon dense fields of light (e.g. LIDRAR or infrared), and as distance to an object grows, the resolution of such sensors, to the extent they function at all, decreases dramatically. In such a case, it is impossible to generate an accurate, intricate depth map and associated images for a complex, irregular physical object such as a bicycle (e.g. wheels, frame, spokes, etc.).

A better system that is capable of multiple resolutions and of capturing large, irregular objects with sufficient detail to create a detailed and accurate three-dimensional model is desirable.

### DESCRIPTION OF THE DRAWINGS

FIG. 1 is a system for three-dimensional object imaging.

FIG. 2 is a functional diagram of a system for three-dimensional object imaging.

FIG. 3 is a block diagram of a computing device.

FIG. 4 is a flowchart for three-dimensional object imaging.

FIG. 5 is a perspective view of a three-dimensional object being imaged using a system for three-dimensional object imaging.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Description of Apparatus

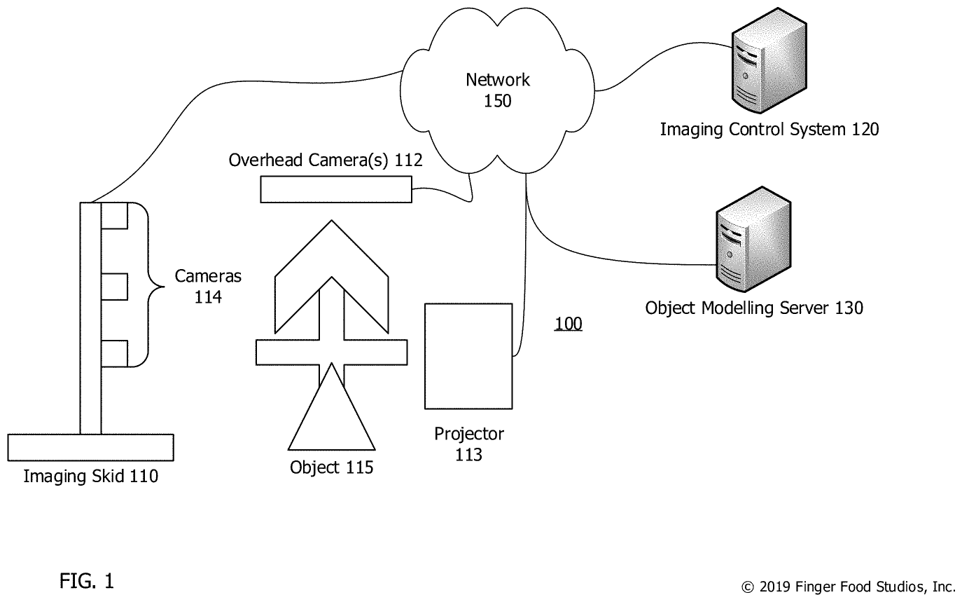

Referring now to FIG. 1, a system 100 for three-dimensional object imaging is shown. The system 100 includes an imaging skid 110, overhead camera(s) 112, a projector 113, a set of cameras 114 an object 115, an imaging control system 120, and an object modelling server 130, all interconnected by a network 150.

The imaging skid 110 is a mobile mount for a series of cameras 114 at various heights. Preferably, sufficient independent cameras 114 are fixed on the imaging skid 110 such that 60% overlap in field of view between cameras for a given object being imaged are present. These cameras 114 are arranged at regular intervals up a tower, pillar, or similar rig fixed to a movable base. In some cases, the base of an imaging skid 110 may be fixed to a ceiling or overhead scaffold or independent wires (e.g. the follow cameras in professional football games and other, outdoor sporting events). In some cases, since the imaging skid 110 moves, pairs of cameras may not be required. Instead, a single camera may be moved a known distance between images, and images from that same camera may be used to generate stereographic pairs of images.

The pairs of cameras may be more than pairs with triplets or full 360° cameras or groups of cameras mounted in regular intervals along a tower or pillar. The cameras 114 may generate a series of images at fixed locations along a path around the object 115, or may generate frame-by-frame video including thousands of images. The path may intentionally choose a uniform distance (e.g. be circular) because for some objects, that may provide additional data useful for photogrammetry. In other cases, different paths (e.g. square or t-shaped or with several paths both close to the object and more distant from the object) may be used, dependent upon the type of photogrammetry used or other available data. Either may be used to generate the eventual three-dimensional model and one may be used over the other for quicker or better object modelling or to conserve storage space. The imaging skid 110 may also incorporate LIDAR, infrared depth sensors, or other point cloud, light-based or sound-based depth sensors.

Of import for the purposes of the imaging skid 110 discussed herein, the skid 110 must be capable of some kind of independent, or self-guided, movement under the control of the imaging control system 120 or of its own onboard computing device. In the most basic setup, the imaging skid may be a flat or largely flat, weighted base fixed on three or more wheels, with some of those wheels capable of propelling (e.g. fixed to a motor or similar conveyance) the imaging skid 110 around an object to be imaged. Some of the wheels may be turnable or alterable under the control of the imaging control system 120 such that the imaging skid 110 may move about an object in a circular fashion.

In other cases, as indicated above, the imaging skid may be movable as fixed to a series of wires hanging over the object to be imaged, with the wheels maintaining and altering the imaging skid 110's position on the wires. In other cases, the imaging skid 110 may be designed in such a way to hang from an overhead scaffold or ceiling and move about using rails.

In still other cases, the imaging skid 110 may be fully self-contained and may operate as a flying drone. In such a case, a tower or pillar of cameras and depth sensors may not be necessary. Instead, a flying drone may move in a pattern about an object to be imaged at a fixed distance multiple times at different heights relative to the ground. In such a way, the flying drone imaging skid 110 may gather a similar set of images and depth information to generate a three-dimensional model as described herein with respect to the imaging skid 110 that is fixed on the ground or a ceiling or scaffold.

In whatever form the imaging skid 110 takes, it may also incorporate one or more downward-facing or non-object-facing cameras for tracking movement of the imaging skid 110 as it images an object 115. For example, a downward-facing camera may track a path physically drawn on the floor or an upward-facing one may track a path drawn on a ceiling. A downward-facing camera may work with the overhead camera(s) 112 to move the skid from computer-readable symbol to computer-readable symbol (e.g. a QR code) on the floor or ceiling in locations from which an operator desires to capture a series of images or along a path (e.g. between two codes) where an operator wishes to capture a series of images. In another alternative, an outward-facing depth sensor, such as an RGB/RGB-D/D sensor, may generate depth data to keep the imaging skid 110 at a fixed distance from an outer wall. This depth sensor data may utilize simultaneous localisation and mapping (SLAM) to guide the imaging skid 110 in a desired (or dynamic) path around the object 115. Alternatively, an inward-facing depth sensor may generate data used to keep the imaging skid 110 at a fixed distance from the object 115 or from a center-point (e.g. a pillar) on which the object 115 is mounted or to which it is fixed. In this way, the imaging skid 110 may be maintained at known locations and/or distances from which stereography may be used to generate the eventual three-dimensional model of the object 115.

The overhead camera(s) 112 are video and, potentially, depth camera(s) that view the entirety of the object 115 and the imaging skid 110 as the imaging skid 110 moves around the object 115 to provide guidance and additional information to the imaging control system 120 (or imaging skid 110) to direct its movements relative to the object 115. The overhead camera(s) 112 may be ordinary RGB video cameras, the resulting images from which computer vision techniques are applied to enable the resulting data to determine the location and general characteristics of the object 115, the location and orientation of the imaging skid 110 relative to the object 115, the overall path or desired path for the imaging skid 110 as it captures images of the object 115, and to provide any desired adjustments to the imaging control system 120 so that the imaging skid 110's path may be altered or updated as needed.

A projector 113 may be optionally included in some cases. A projector may be a part of a depth sensor (discussed above) such as a LIDAR or infrared sensor. Or, a projector 113 may be independently provided. The projector 113 may project a design, shape or, light of a known type onto an object being imaged. Cameras, such as cameras 114 viewing that projected design may use photogrammetry to extrapolate features of the design. For example, at a specific distance, a projection of a cross-hatched pattern on an object is known, if the object is flat, to have a certain width and height. That information can be used to derive the overall parallelism of an object's face to the cameras 114, the angle at which a given face is presented, and to calculate curves of that object and subsequent depths at different points on the object. A projector 113 is particularly useful for objects lacking in significant features or with long, continuous faces (e.g. a tent or canoe).

The object 115 is any object being imaged. For purposes of this disclosure, irregular objects, such as bicycles or kayaks, are discussed because they present the most difficult characteristics for traditional three-dimensional imaging systems to capture, but that are more suitable for imaging in the present system.

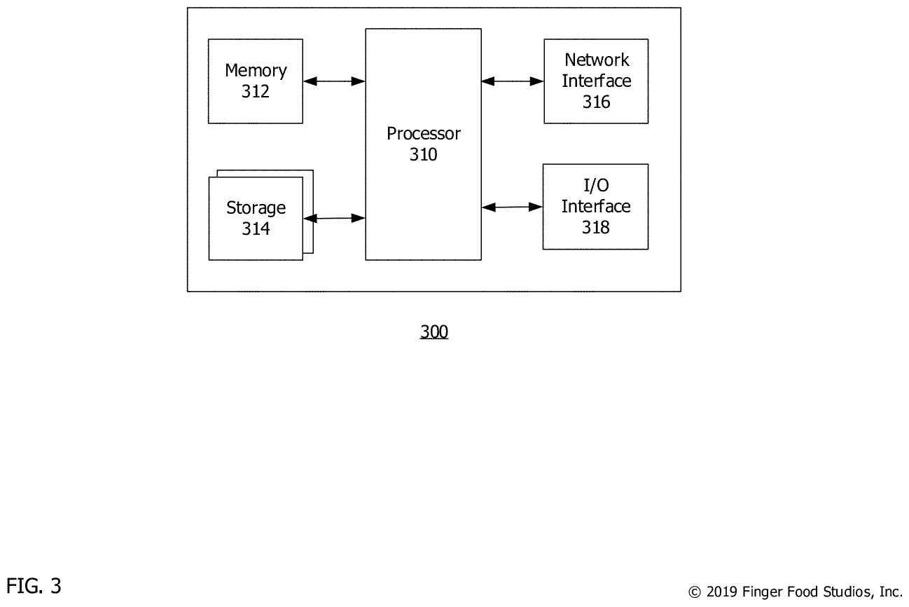

The imaging control system 120 is a computing device (FIG. 3) that operates to control the movement of the imaging skid 110 as it images an object 115 and to store images created by the imaging skid 110 as it generates those images. For example, the imaging control system 120 may control the movement of the imaging skid 110 so that it is self-guided, and does not require guidance from an operator or external markers or guides (e.g. lines on a floor or ceiling or QR or similar computer-readable codes). The imaging control system 120 is shown as separate from the imaging skid 110, but it may in some cases be fully or partially incorporated into the imaging skid 110 itself. For example, some of the guidance processes that direct the location of the imaging skid 110 may be integrated into the imaging skid 110 itself.

The object modelling server 130 is a computing device (FIG. 3) that converts the generated stereoscopic images, video, and depth data at known distances from the object 115 into a complete three-dimensional model of the object 115. The object modelling server 130 may or may not be a part of the overall system 100. Specifically, the object modelling server 130 may take place as a part of the system 100 such that the output to another is the completed three-dimensional model of the object 115. In other cases, for example, cases where a customer or other wishes to generate the model themselves, the output may be the series of uniform images or video and depth data that may be converted into a three-dimensional model. In those cases, the object modelling server 130 may be operated by the customer or another.

The network 150 is communications hardware and associated protocols that enable communication between the various components. This network 150 may be or include the internet, Ethernet, 802.11x wireless networks, Bluetooth, and may in some cases include more direct connections such as USB, or other wired connections (particularly for generation of large imaging data by the cameras 114 for storage on the imaging control system 120).

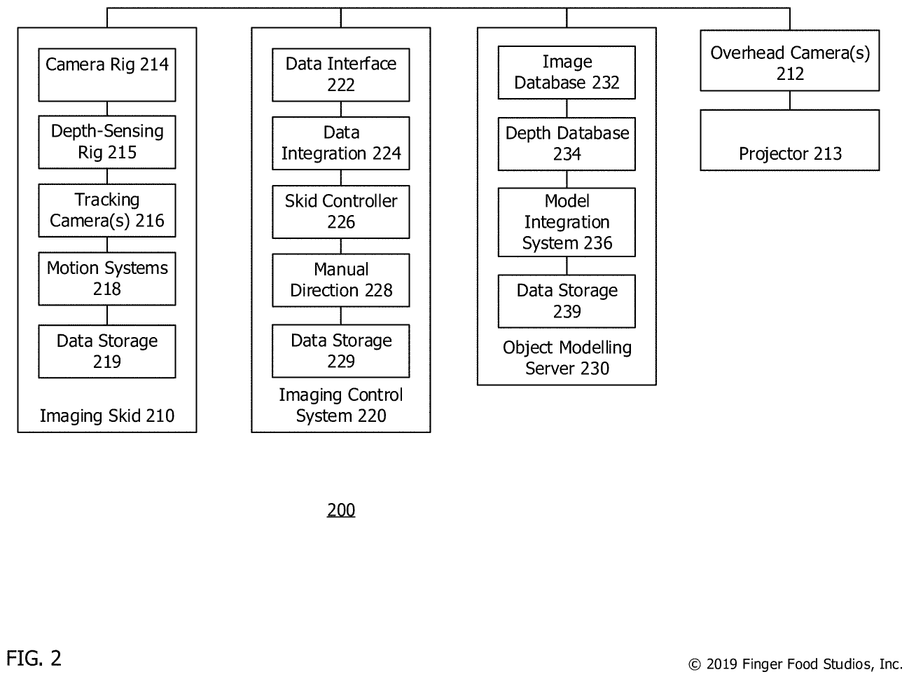

FIG. 2 is a functional diagram of a system 200 for three-dimensional object imaging. The system 200 includes the same imaging skid 210, overhead camera(s) 212, imaging control system 220, and object modelling sever 230 shown in FIG. 1. In FIG. 2, sub-functions of those components are also shown.

The imaging skid 210 includes a camera rig 214, a depth-sensing rig 215, tracking camera(s) 216, motion systems 218, and data storage 219. The camera rig 214 is described above. It may be a single camera, or camera pairs, or may be a set of three or more cameras with overlapping fields of view. The camera rig 214 preferably includes video cameras capturing many frames of video per second so that multiple sets of images may be used, throughout the overall shooting process, to generate the eventual three-dimensional model. In addition, the capture of many frames enables the model integration system 236 (discussed below) to compensate for any problems in some of the frames or images. The camera rig 214 captures images of an object to be modelled from many perspectives so that the eventual three-dimensional model may be created.

The depth-sensing rig 215 may be or include the camera(s) of the camera rig 214. However, the depth-sensing rig 215 may also include depth sensors of various types. The most common are light-based sensors such as LIDAR or infrared sensors such as those used in the Microsoft® Kinect® system. Though, other point-cloud systems and sound-based (e.g. eco-location) exist as well. The sensors used in the depth-sensing rig 215 typically have a fixed resolution. As a result, they can only function from certain distances. For example, infrared-based sensors operate best at a distance of less than 20 feet and indoors. Otherwise, they are washed-out by bright lights or the sun. However, at those distances, their resolution is quite good for accurately representing, even objects of small variations in depths. In contrast, LIDAR resolution is quite poor, with only hundreds or thousands of points in a point cloud, but its operating distance is quite large. It can work outdoors and across more than one hundred feet of distance in most cases. To compensate, moving either the LIDAR or infrared systems to various depths from the object being imaged can dramatically increase accuracy. Then, resulting three-dimensional models can be overlaid one on another with the one captured “closer” to the object taking precedence either entirely, or merely to add more details (e.g. the spokes of a bicycle may not be visible to infrared depth sensors at 10 feet distance, but may be at 2 feet).

The tracking camera(s) 216 are used to assist in keeping the imaging skid 210 on a predetermined course. Preferably, this course is at a set distance for all images of an object for at least one full revolution around that object. In this way, the depth may be more accurately calculated for the entire object and, thus, its dimensional characteristics more accurately mapped. The tracking camera(s) 216 may rely upon paths laid out on the ground or the ceiling, QR or other machine-readable codes placed at various intervals along the course, or upon a set track laid-out before imaging occurs. In some cases, tracking camera(s) 216 may merely incorporate depth data to keep the imaging skid 210 at a fixed distance from a known center point such as a rack or pole or other mount for the object. A single computer-vision readable object may be hung at a center point for a desired object imaging process (e.g. by a string hanging from the ceiling), and the tracking camera(s) 216 may use that object to continuously adjust the pathing of the imaging skid 210 as it moves about an object being imaged so as to maintain the desired distance or distances (if multiple circuits of the object are taken).

The motion systems 218 are motors or engines, and steering mechanisms that move the imaging skid 210 from place to place around the object. As indicated above, these may be wheels and motors powered by electricity or batteries, or may be wires, or propellers that move a hanging or flying imaging skid 210 around the object.

The data storage 219 is simply non-transitory storage for the images and depth data created by the camera rig 214, the depth sensing rig 215, and the tracking camera(s) 216. The data storage 219 is temporary in the sense that the data storage 219 may be emptied, either manually by transmission to another device (e.g. the object modelling server 230) or automatically by transmission to the imaging control system 220 as the data is created or at fixed intervals or as a complete circuit of an object being imaged is completed.

The overhead camera(s) 212 may generate overhead imaging data that is used, alone or in conjunction with the tracking camera(s) 216 to guide the motion systems 218 of the imaging skid 210 as it traverses around an object being imaged. Likewise, projector 213 (which may in fact be multiple projectors or may be mounted to the imaging skid 210) projects images, visible or invisible to the naked eye, that may be used in photogrammetry.

The imaging control system 220 includes a data interface 222, data integration 224, a skid controller 226, manual direction 228, and data storage 229.

The data interface 222 enables the imaging control system 220 to receive or request data from the imaging skid 210. The data may include image data, depth data, and/or motion and tracking data for the skid 210. The data interface 222 may also enable the imaging control system 220 to send instructions such as pathing instructions, and movement parameters to the imaging skid 210.

The data integration 224 system may be used to simultaneously integrate data from the tracking camera(s) 216 and the overhead camera(s) 212 or other sources to determine from moment to moment the location and pathing for the imaging skid 210. The data integration 224 system may operate to combine data from those various sources into data that may be used by the imaging control system 220 to control the skid 210.

The skid controller 226 is software that directs the movement of the skid 210. The skid controller 226 may provide an overall path and distance parameter and allow the skid 210 itself to constantly determine its own path to accomplish the desired result, such that the skid 210 is self-guided. Alternatively, the skid controller 226 may operate on a moment to moment basis to provide ongoing instructions and motion parameters for the skid 210. This will be based upon the synthesized data generated by the data integration 224.

The manual direction 228 may enable an operator of the imaging control system 220 to take control of the imaging skid 210 in a manual mode, essentially controlling movement of the skid by hand using a video game controller, a series of commands, or other methods.

Data storage 229 may store data pertaining to the images generated by the overhead camera(s) 212 and the tracking camera(s) 216. Data storage 229 may also store data generated by the camera rig 214 and the depth-sensing rig 215 as well as data regarding the distance or distances at which the imaging skid 210 circled the object as it was being imaged. This data may be used both in controlling pathing of the skid 210 but also by the object modelling server 230 in generating the eventual three-dimensional model of the object.

The object modelling server 230 includes an image database 232, a depth database 234, a model integration system, and data storage 239.

The image database 232 is a database of image data generated through analysis of the image data generated by the imaging skid 210 and stored in the data storage 239. The depth database 234 is similar, but it stores depth data that is the result of analysis of the depth data captured by the imaging skid 210.

The model integration system 236 takes the two sources of data for a given object that are generated by the imaging skid 210 and generates a three-dimensional model of the object. As will be discussed more fully below, both the images and the depth data may be captured at multiple distances from the object. Various algorithms may be used for object modelling by the model integration system 236. Once created, the three-dimensional model may be stored in data storage 239 so that it may be shared or used for other purposes (e.g. inserted into a VR or AR environment or used in a video game engine for various purposes).

Turning now to FIG. 3, a block diagram of a computing device 300 is shown. The computing device 300 may be representative of the server computers, client devices, mobile devices and other computing devices discussed herein. The computing device 300 may include software and/or hardware for providing functionality and features described herein. The computing device 300 may therefore include one or more of: logic arrays, memories, analog circuits, digital circuits, software, firmware and processors. The hardware and firmware components of the computing device 300 may include various specialized units, circuits, software and interfaces for providing the functionality and features described herein.

The computing device 300 may have a processor 310 coupled to a memory 312, storage 314, a network interface 316 and an I/O interface 318. The processor 310 may be or include one or more microprocessors and application specific integrated circuits (ASICs).

The memory 312 may be or include RAM, ROM, DRAM, SRAM and MRAM, and may include firmware, such as static data or fixed instructions, BIOS, system functions, configuration data, and other routines used during the operation of the computing device 300 and processor 310. The memory 312 also provides a storage area for data and instructions associated with applications and data handled by the processor 310. As used herein, the word memory specifically excludes transitory medium such as signals and propagating waveforms.

The storage 314 may provide non-volatile, bulk or long-term storage of data or instructions in the computing device 300. The storage 314 may take the form of a disk, tape, CD, DVD, SSD, or other reasonably high capacity addressable or serial storage medium. Multiple storage devices may be provided or available to the computing device 300. Some of these storage devices may be external to the computing device 300, such as network storage or cloud-based storage. As used herein, the word storage specifically excludes transitory medium such as signals and propagating waveforms.

The network interface 316 is responsible for communications with external devices using wired and wireless connections reliant upon protocols such as 802.11x, Bluetooth®, Ethernet, satellite communications, and other protocols. The network interface 316 may be or include the internet.

The I/O interface 318 may be or include one or more busses or interfaces for communicating with computer peripherals such as mice, keyboards, cameras, displays, microphones, and the like.

Description of Processes

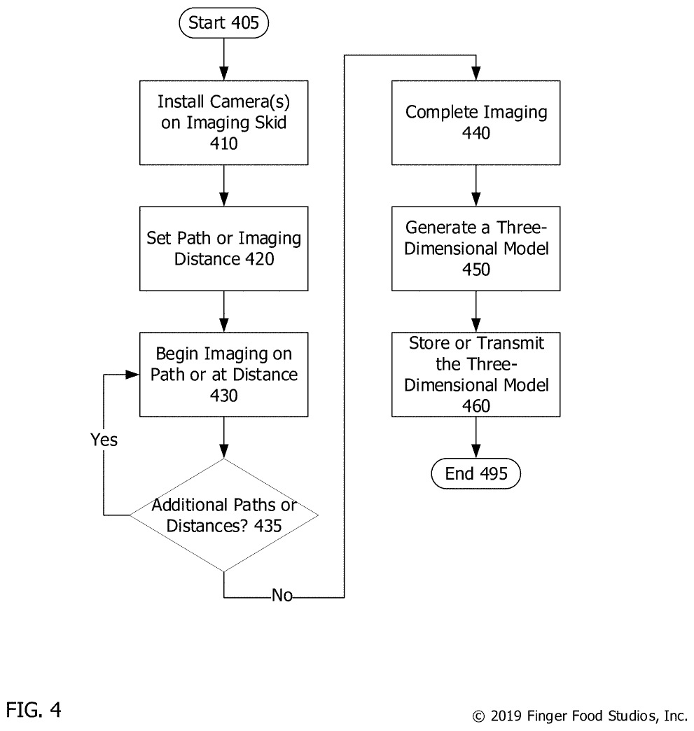

FIG. 4 is a flowchart for three-dimensional object imaging. The flow chart has both a start 405 and an end 495, but the process is cyclical in nature. As an object is being imaged or as multiple objects are being imaged, the steps of the flowchart may take place many times or at various distances from the same object. Multiple passes through the flowchart may improve resolution or accuracy of the resulting three-dimensional model.

Following the start 405, the first step is to install the camera(s) on the imaging skid 410. This step includes the physical installation of the camera(s) on the imaging skid, but also includes any calibration. For example, the distances between the lenses of camera pairs may be calibrated so that the depth data from stereography may be accurately measured if sterography is used. If photogrammetry is used, this step is optional, though some calibration of the projected matrices, or other images, and their relationships to the cameras may take place. The distances between cameras on the camera rig may also be useful to get a second set of stereography data points. The depth sensors may also require calibration to ensure they are accurately measuring depth.

The skid must also be set up in such a way that it is capable of movement. This may be placing the skid on wheels, setting up the scaffold or wall mounts, or any wires for the imaging skid.

Next, the operator must use the imaging control system, and potentially physical alteration to the environment, to set a path or imaging distance for the skid at 420. This may be as simple as instructing the imaging control system to image a given object at a distance of 10 feet, 4 feet, and 2 feet from the object. In an automated system, a center point may be determined (e.g. using a physical marker at a center point or over the object) and the imaging control system may automatically instruct the imaging skid in maintaining those distances and creating appropriate images.

In some cases, it may be simplest to draw a physical path or a set of physical paths on the ground in the form of a white line that the tracking cameras can follow along the ground. Alternatively, a series of QR or similar codes may be used to set the path at 420. In still other cases, the imaging skid may be placed on a physical rail system or other system that ensures a specific pathing for the imaging skid at 420.

Next, the imaging skid begins imaging on path or at desired distance at 430. At this phase, the imaging skid moves around the object being imaged, while being careful to use the path or imaging distance to maintain the known, desired distance. In this way, images at the same depth may be compared to generate a more accurate three-dimensional model for the object.

Next, a determination is made at 435 whether there are additional paths or distances at which the imaging system is to operate. Specifically, for objects of irregular characteristics, e.g. the spokes of a bicycle or a kayak, certain distances may not be sufficient to generate an accurate three-dimensional model from the resulting data. For other objects, e.g. a surfboard, a single pass at a set distance may be sufficient. The operator may require or suggest, or the system may automatically perform, imaging at various distances to improve the accuracy of the resulting three-dimensional model.

If additional paths or distances are desired (“yes” at 435), then the imaging at that path or distance are repeated at 430 and another determination regarding additional paths or distances is made at 435.

If no additional paths or distances are desired (“no” at 435), then the imaging process completes at 440. This may include a step of storing the generated image and depth data, and may include transmission of that data to a remote computing device or server, such as the imaging control system 220 or the object modelling server 230 (FIG. 2).

Next, the object modelling server 230 (FIG. 2) may be used to generate a three-dimensional model at 450. As indicated above, there are various methods for performing this function. The most basic involves stereography reliant upon multiple sets of images of the same object taken at the same distance, but from different perspectives. That data alone may be used to create a baseline three-dimensional model. Then, the data may be refined or added to using depth data gathered at the same time. Alternatively, the depth data may be used as a baseline because it is more accurate, but the image data and stereography used only to confirm the depth of various aspects of the object. The image data may also be used to generate so-called textures for the eventual three-dimensional model that match the actual appearance of the object. The images may be “wrapped” around the object, with the images edited to provide the best perspective for objects with a front-on view from the camera depending on where the cameras were when the photographs were taken. In this way, many images may be stitched together to form a texture for a given model. Other methods rely upon integration of multiple passes around the same, fixed, object with one or more passes capturing image data representative of the object's texture, with other passes representative of the objects depth from the camera (from which to derive the physical shape of the object). Or, those passes may be simultaneous with one another, with images taken with and without projections visible. Other data, e.g. infrared data, is invisible to RGB cameras and may be captured simultaneously with texture capture. Various methods exist for integrating the data captured by the proposed method and generating three-dimensional images and models.

Next the three-dimensional model is stored and/or transmitted to a desired location for use at 460. At this stage, the resulting model may be integrated into an augmented reality or virtual reality environment or a game engine for virtually any purpose. Some typical purposes may be to integrate real-world objects into game or virtual reality or augmented reality environments for purposes of additional immersive experience within those environments. Other purposes may include online advertising or advertising for real-world products in three-dimensional environments such as VR, AR and video games.

The process then ends at 495.

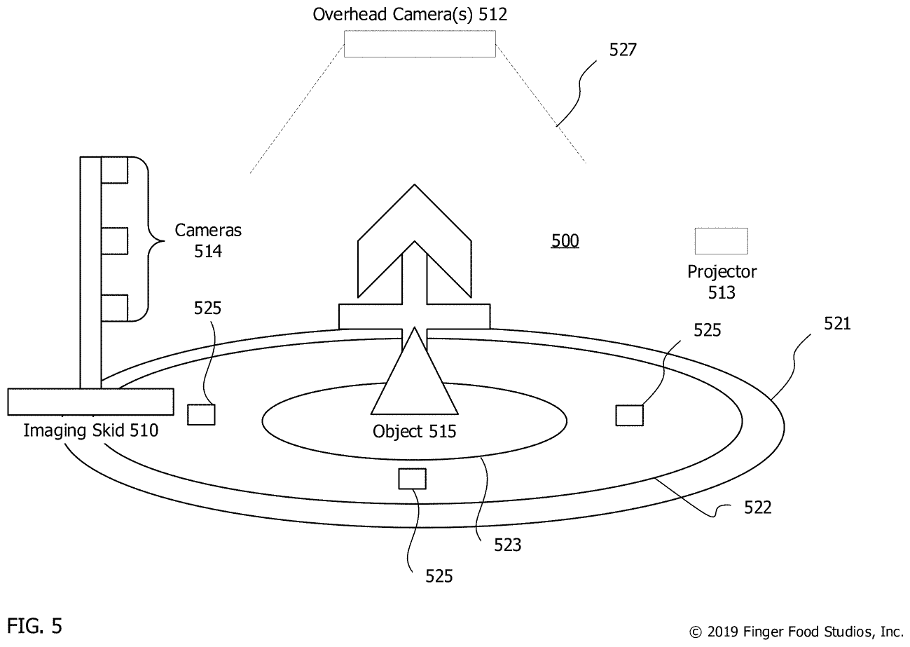

Referring now to FIG. 5, a perspective view of a three-dimensional object being imaged using a system 500 for three-dimensional object imaging. This perspective shows the overhead camera(s) 512 with their full field perspective 527 of the entirety of the environment in which the imaging skid 510 is moving to capture images of the object 515 using the cameras 514. A series of different paths 521, 522, and 523 may be designated at different distances from the object 515. Though shown as circular, other paths may be used as well. As discussed above, this is to enable the object's characteristics, particularly fine details of the three-dimensional characteristics of the object, to be imaged and detected by depth sensors on the imaging skid 510.

The paths 521, 522, and 523 are shown as concentric circles of different radii that are physically drawn on the ground around the object 515. However, a series of QR codes 525 may also be used or used instead. Alternatively, as discussed above, the depth sensors on the imaging skid 510 may maintain set distances from a center point. The overhead camera(s) 512 and projector 513 may aid in this process. In still other cases, no path may be visibly defined at all, instead relying wholly upon depth sensors and/or overhead camera(s) 512 and may move irregularly to ensure the best overall model is created.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system for generating a three-dimensional model of a physical object comprising:
a camera skid placed at a known distance from the physical object and moved fully around the physical object at the known distance;
a set of cameras on the camera skid for capturing image data at a series of locations around the physical object; and
a computing device for generating a three-dimensional model of the physical object using the known distance and the image data.

2. The system of claim 1 wherein the camera skid further includes depth sensors, and wherein depth sensor data generated by the depth sensors is combined with the image data to convert the image data into a three-dimensional model of the physical object using the known distance.

3. The system of claim 2 wherein the camera skid is maintained at the known distance using, at least in part, the depth sensor data relative to the physical object.

4. The system of claim 3 wherein the known distance changes as images are created, but is determined using the depth sensor data for each image.

5. The system of claim 1 wherein the known distance is defined by at least one of a physical line drawn on a floor below or a ceiling above the camera skid, a series of machine-readable symbols affixed to the floor or the ceiling, depth sensors tracking a location of the camera skid relative to a fixed object or marker relative to the physical object, and a second camera tracking the camera skid as it moves along and communicating location data to the camera skid for adjustment to pathing of the camera skid.

6. The system of claim 1 wherein a substantially uniform background is included surrounding the physical object to provide for higher contrast when capturing the image data.

7. The system of claim 1 wherein the known distance is determined, at least in part, using depth sensor data generated by one or more depth sensors on the camera skid and an analysis of the size and complexity of the physical object.

8. The system of claim 1 wherein:
the camera skid is moved at a second known distance, closer than the known distance, fully around the physical object to capture more details of the physical object;
the set of cameras on the camera skid capture additional image data at a second series of locations around the physical object; and
the computing device generates the three-dimensional model of the physical object using the known distance and the second known distance, the additional image data, and the image data.

9. Apparatus comprising non-volatile machine-readable medium storing a program having instructions which when executed by a processor will cause the processor to:
maintain a camera skid at a known distance from the physical object;
move the camera skid at the known distance fully around the physical object
capture image data using a set of cameras on the camera skid at a series of locations around the physical object; and
generate a three-dimensional model of the physical object using the known distance and the image data.

10. The apparatus of claim 9 wherein the known distance is defined by at least one of a physical line drawn on a floor below or a ceiling above the camera skid, a series of machine-readable symbols affixed to the floor or the ceiling, depth sensors tracking a location of the camera skid relative to a fixed object or marker relative to the physical object, and a second camera tracking the camera skid as it moves around the physical object and communicating location data to the camera skid for adjustment to pathing of the camera skid.

11. The apparatus of claim 9 wherein the instructions further cause the processor to:
move the camera skid at a second known distance, closer than the known distance, fully around the physical object to capture more details of the physical object;
capture additional image data using the set of cameras on the camera skid at a second series of locations around the physical object; and
use the additional image data, along with the image data to generate the three-dimensional model of the physical object using the known distance and the second known distance.

12. The apparatus of claim 9 further comprising:
the processor;
a memory;
wherein the processor and the memory comprise circuits and software for performing the instructions on the storage medium.

13. A method of generating a three-dimensional model of a physical object comprising:
placing a camera skid at a known distance from the physical object;
moving the camera skid at the known distance fully around the physical object capturing image data using a set of cameras on the camera skid at a series of locations around the physical object; and
generating a three-dimensional model of the physical object using the known distance and the image data.

14. The method of claim 13 wherein the camera skid further includes depth sensors, and wherein depth sensor data generated by the depth sensors is combined with the image data to convert the image data into a three-dimensional model of the physical object using the known distance.

15. The method of claim 14 wherein the camera skid is maintained at the known distance using, at least in part, the depth sensor data relative to the physical object.

16. The method of claim 15 wherein the known distance changes as images are created, but is determined using the depth sensor data for each image.

17. The method of claim 13 wherein the known distance is defined by at least one of a physical line drawn on a floor below or a ceiling above the camera skid, a series of machine-readable symbols affixed to the floor or the ceiling, depth sensors tracking a location of the camera skid relative to a fixed object or marker relative to the physical object, and a second camera tracking the camera skid as it moves along the known distance and communicating location data to the camera skid for adjustment to pathing of the camera skid.

18. The method of claim 13 wherein a substantially uniform background is included surrounding the physical object to provide for higher contrast when capturing the image data.

19. The method of claim 13 wherein the known distance is determined, at least in part, using depth sensor data generated by one or more depth sensors on the camera skid and an analysis of the size and complexity of the physical object.

20. The method of claim 13 further comprising:
moving the camera skid at a second known distance, closer than the known distance, fully around the physical object to capture more details of the physical object;
capturing additional image data using the set of cameras on the camera skid at a second series of locations around the physical object; and
using the additional image data, along with the image data to generate the three-dimensional model of the physical object using the known distance and the second known distance.
